(19) United States
(12) Patent Application Publication
(10) Pub. No.: US 2012/0231280 A1
(43) Pub. Date: Sep. 13, 2012

(54) COMPONENT COMPRISING AN INSERT PART AND PLASTICS JACKETING, AND PROCESS FOR PRODUCTION OF THE COMPONENT

(75) Inventors: Rebekka von Benten, Ludwigshafen (DE); Alireza Talebloo, Mainz (DE); Harald Kröger, Bohl-lggelheim (DE); Peter Eibeck, Speyer (DE); Kai Oliver Siegenthaler, Mannheim (DE)

(73) Assignee: BASF SE, Ludwigshafen (DE)

(21) Appl. No.: 13/510,411

(22) PCT Filed: Nov. 16, 2010
(86) PCT No.: PCT/EP2010/067521

§ 371 Date: May 17, 2012

(30) Foreign Application Priority Data
Nov. 18, 2009 (EP) 09176360.7

(51) Int. Cl. B32B 27/36; B32B 17/10; B32B 15/09; B29C 45/14

(52) U.S. Cl. 428/430; 428/480; 264/265; 428/458

(57) ABSTRACT

The invention relates to a component comprising an insert part and plastics jacketing composed of at least two plastics components, where the insert part is enclosed by a first plastics component A and there is a second plastics component B enclosing the first plastics component A, where the first plastics component A is composed of:
A1: from 5 to 80% by weight, based on the total weight of components A1 and A2, of at least one polyester based on aliphatic and aromatic dicarboxylic acids and on aliphatic dihydroxy compounds;
A2: from 20 to 95% by weight, based on the total weight of components A1 and A2, of at least one homo- or copolyester selected from the group consisting of polylactide (PLA), polycaprolactone, polyhydroxyalkanoates, and polyester derived from aliphatic dicarboxylic acids and from aliphatic diols;
A3: from 0.05 to 15% by weight, based on the total weight of components A1 and A2, a) of a copolymer which contains epoxy groups and which is based on styrene, on acrylate, and/or on methacrylate, b) of a bisphenol A epoxide, or c) of a fatty acid amide or fatty acid ester, or natural oil containing epoxy groups;
   and the second plastics component B is composed of
B1: from 50 to 100% by weight of at least one semicrystalline, thermoplastic polyester based on aromatic dicarboxylic acids and on aliphatic or aromatic dihydroxy compounds and
B2: from 0 to 50% by weight of at least one thermoplastic styrene (co)polymer,
   in each case based on the polymer content of the second plastics component B.

The invention relates to a component comprising an insert part and plastics jacketing composed of at least two plastics components, where the insert part is enclosed by a plastics component A and there is a second plastics component B enclosing the first plastics component A. The invention further relates to a process for the production of this component.

Components which comprise an insert part and plastics jacketing are used by way of example when metallic insert parts are used for the integration of electronics components, e.g. in automobile technology or in aerospace technology. A leakproof or coherent bond is required in the component here, in order to prevent ingress of moisture or liquid and resultant damage to the electronic components. The component has to remain leakproof even when it is subject to temperature variations. One reason for defective leakproof properties in the coherent bond in composite structures composed of a metallic insert part with plastics jacketing can derive for example from poor wetting of the metal component by the plastics component, resulting in poor adhesion. Differences in the thermal expansion of the metallic component and of the plastics component also lead to stresses which can cause cracks.

A component in the form of a plug in which plastics jacketing encloses a metallic insert part is known by way of example from EP-B 0 249 975. In order to achieve a leakproof bond between plastic and metal, there is a flexible plastics material introduced between the exterior plastics material and the metallic insert part. The flexible plastics material is, for example, an unreinforced thermoplastic elastomer.

EP-A 1 496 587 discloses a composite component in which a flat cable is passed out from a sealed structure composed of a plastics material. In order to seal the gap where the cable emerges from the plastics material, the aperture is filled by a liquid rubber, which is then cured.

DE-C 100 53 115 also describes a passageway for a cable composed of a plastics jacket. The sealing here is achieved via a sealant which has adhesive properties both with respect to the material of the bushing and with respect to the jacket material of the lines. Examples mentioned of suitable sealants are fat, wax, resin, bitumen, or the like.

Another plug connector in which a solid jacket composed of a plastics material receives metallic pins is known from EP-A 0 245 975. A flexible plastics material is used between the metal pins and the exterior jacket, in order to achieve a leakproof bond.

WO-A 2008/099009 also discloses a component in which a plastics layer jackets an insert part. The metallic insert part in said component is first sheathed by a low-viscosity plastics composition, and, in a second step, a hard plastics component is injected around the sheathing. Suitable plastics mentioned which have the low viscosity are polyamides, aliphatic polyesters, or polyesters based on aliphatic and aromatic dicarboxylic acids and on aliphatic dihydroxy compounds.

DE-B 10 2005 033 912 discloses another casing passageway in which an electrical contact is conducted through a casing. The casing passageway has been sealed in such a way as to preventingress of undesired substances. In order to achieve sealing, a galvanizing process is used to increase the roughness depth of the conductor element in the region of sealing.

A disadvantage of plastics sheathing of insert parts throughout the prior art is that it does not provide adequate leakproof properties, in particular when it is used under conditions of temperature change.

It is therefore an object of the present invention to provide a component which comprises an insert part and plastics jacketing, and in which the plastics jacketing provides adequate leakproof properties even during storage under conditions of temperature change.

The object is achieved via a component comprising an insert part and plastics jacketing composed of at least two plastics components, where the insert part is enclosed by a first plastics component A and there is a second plastics component B enclosing the first plastics component A, wherein the first plastics component A is composed of:
A1: from 5 to 80% by weight, based on the total weight of components A1 and A2, of at least one polyester based on aliphatic and aromatic dicarboxylic acids and on aliphatic dihydroxy compounds;
A2: from 20 to 95% by weight, based on the total weight of components A1 and A2, of at least one homo- or copolyester selected from the group consisting of polylactide (PLA), polycaprolactone, polyhydroxyalkanoates (e.g. PHB or PHB/V), and polyester derived from aliphatic dicarboxylic acids and from aliphatic diols;
A3: from 0.05 to 15% by weight, based on the total weight of components A1 and A2, a) of a copolymer which contains epoxy groups and which is based on styrene, on acrylate, and/or on methacrylate, b) of a bisphenol A epoxide, or c) of a fatty acid amide or fatty acid ester, or natural oil containing epoxy groups;
   and the second plastics component B is composed of
B1: from 50 to 100% by weight of at least one semicrystalline, thermoplastic polyester based on aromatic dicarboxylic acids and on aliphatic or aromatic dihydroxy compounds and
B2: from 0 to 50% by weight of at least one thermoplastic styrene (co)polymer,
   in each case based on the polymer content of the second plastics component B.

The use of the first plastics component A, which is composed of the at least one polyester based on aliphatic and aromatic dicarboxylic acids and on aliphatic dihydroxy compounds A1 (hereinafter termed semiaromatic polyesters), and of the at least one homo- or copolyester A2, and of component A3, used as compatibilizer, achieves markedly improved leakproof properties when comparison is made with the plastics jacketing known from the prior art, in particular when the component is used under conditions of temperature change.

Among the particularly preferred semiaromatic polyesters A1 are polyesters which comprise, as essential components,
1) an acid component composed of
   1a) from 30 to 99 mol % of at least one aliphatic or at least one cycloaliphatic dicarboxylic acid, or ester-forming derivatives thereof, or a mixture thereof,
   1b) from 1 to 70 mol % of at least one aromatic dicarboxylic acid, or ester-forming derivative thereof, or a mixture thereof, and
   1c) from 0 to 5 mol % of a compound containing sulfonate groups,
2) a diol component selected from at least one C₂-C₁₂ alkanediol, from at least one C₅-C₁₀ cycloalkanediol, or a mixture thereof,
   and, if appropriate, also comprising one or more components selected from
3) a component selected from
   3a) at least one dihydroxy compound of the formula I comprising ether functions

HO—[(CH₂)ₙ—O]ₘ—H (I)
in which n is 2, 3, or 4, and m is an integer from 2 to 250,
3b) at least one hydroxycarboxylic acid of the formula IIa or IIb

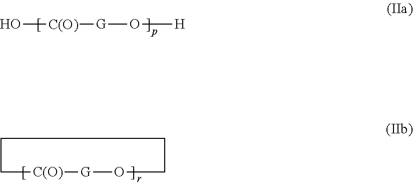

in which p is an integer from 1 to 1500 and r is an integer from 1 to 4, and G is a radical selected from the group consisting of phenylene, —(CH₂)_{q}—, where q is an integer from 1 to 5, —C(R)H— and —C(R)HCH₂, where R is methyl or ethyl,
3c) at least one amino-C₂-C₁₂ alkanol or at least one amino-C₅-C₁₀ cycloalkanol, or a mixture thereof,
3d) at least one diamino-C₁-C₈ alkane,
3e) at least one 2,2′-bisoxazoline of the general formula III

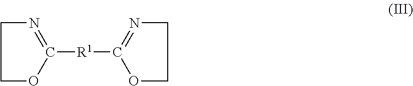

where R¹ is a single bond, a (CH₂)_{z}-alkylene group, where z=2, 3, or 4, or a phenylene group,
3f) at least one aminocarboxylic acid selected from the group consisting of the natural amino acids, polyamides obtainable via polycondensation of a dicarboxylic acid having from 4 to 6 carbon atoms and of a diamine having from 4 to 10 carbon atoms, compounds of the formulae IVa and IVb

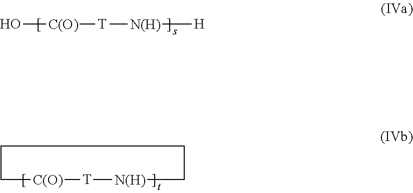

in which s is an integer from 1 to 1500 and t is an integer from 1 to 4, and T is a radical selected from the group consisting of phenylene, —(CH₂)ᵤ—, where u is an integer from 1 to 12, —C(R²)H— and —C(R²)HCH₂, where R² is methyl or ethyl,
and from polyoxazolines having the repeat unit V

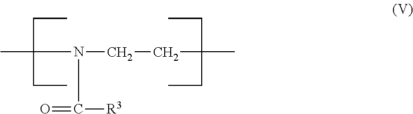

in which R³ is hydrogen, C₁-C₆-alkyl, C₅-C₈-cycloalkyl, phenyl which is unsubstituted or which has up to three substituents that are C₁-C₄-alkyl groups, or is tetrahydrofuryl,
or a mixture of 3a) to 3f),
and
4) a component selected from
   4a) at least one compound having at least three groups capable of ester formation,
   4b) at least one isocyanate,
   4c) at least one divinyl ether,
   or a mixture of 4a) to 4c).

In one preferred embodiment, the acid component 1) of the semiaromatic polyesters A1 comprises from 30 to 70 mol %, in particular from 40 to 60 mol %, of 1a) and from 30 to 70 mol %, in particular from 40 to 60 mol %, of 1b).

Aliphatic acids and the corresponding derivatives 1a) that can be used are generally those having from 2 to 10 carbon atoms, preferably from 4 to 6 carbon atoms. They can be linear or branched. The cycloaliphatic dicarboxylic acids that can be used for the purposes of the present invention are generally those having from 7 to 10 carbon atoms and in particular those having 8 carbon atoms. However, it is also possible in principle to use dicarboxylic acids having a larger number of carbon atoms, for example having up to 30 carbon atoms.

Examples that may be mentioned are: malonic acid, succinic acid, glutaric acid, 2-methylglutaric acid, 3-methylgluratic acid, adipic acid, pimelic acid, azeleic acid, sebacic acid, fumaric acid, 2,2-dimethylglutaric acid, suberic acid, 1,3-cyclopentane-dicarboxylic acid, 1,4-cyclohexanedicarboxylic acid, 1,3-cyclohexanedicarboxylic acid, diglycolic acid, itacolic acid, maleic acid, and 2,5-norbornanedicarboxylic acid.

Particular mention may be made of the following ester-forming derivatives of the abovementioned aliphatic or cycloaliphatic dicarboxylic acids, which can likewise be used, the di-C₁-C₆-alkyl esters, such as dimethyl, diethyl, di-n-propyl, diisopropyl, di-n-butyl, diisobutyl, di-tert-butyl, di-n-pentyl, diisopentyl, or di-n-hexyl esters. It is likewise possible to use anhydrides of the dicarboxylic acids.

The dicarboxylic acids or ester-forming derivatives thereof can be used individually here or in the form of a mixture of two or more thereof.

It is preferable to use succinic acid, adipic acid, azelaic acid, sebacic acid, brassylic acid, or the respective ester-forming derivatives of these, or a mixture thereof. It is particularly preferable to use succinic acid, adipic acid, or sebacic acid, or the respective ester-forming derivatives of these, or a mixture thereof. It is particularly preferable to use adipic acid or ester-forming derivatives thereof, for example the alkyl esters thereof, or a mixture thereof. If polymer mixtures having “hard” or “brittle” components A2 are being produced, an example being polyhydroxybutyrate or in particular polylactide, the aliphatic dicarboxylic acid used preferably comprises sebacic acid or a mixture of sebacic acid with adipic acid. If polymer mixtures having “soft” or “tough” components A2 are being produced, an example being polyhydroxybutyrate-co-valerate, the aliphatic dicarboxylic acid used preferably comprises succinic acid or a mixture of succinic acid with adipic acid.

Another advantage of succinic acid, azelaic acid, sebacic acid, and brassylic acid is that they are accessible in the form of renewable raw materials.

Aromatic dicarboxylic acids 1b) that may be mentioned are generally those having from 8 to 12 carbon atoms and preferably those having 8 carbon atoms. Mention may be made by way of example of terephthalic acid, isophthalic acid, 2,6-naphthoic acid and 1,5-naphthoic acid, and also ester-forming derivatives thereof. Particular mention may be made here of the di-C₁-C₆-alkyl esters, e.g. dimethyl, diethyl, di-n-propyl, diisopropyl, di-n-butyl, diisobutyl, di-tert-butyl, di-n-pentyl, diisopentyl, or di-n-hexyl esters. The anhydrides of the dicarboxylic acids 1b) are equally suitable ester-forming derivatives.

However, it is also possible in principle to use aromatic dicarboxylic acids 1b) having a larger number of carbon atoms, for example up to 20 carbon atoms.

The aromatic dicarboxylic acids or ester-forming derivatives of these 1b) can be used individually or in the form of a mixture made of two or more thereof. It is particularly preferable to use terephthalic acid or ester-forming derivatives thereof, e.g. dimethyl terephthalate.

The compound used containing sulfonate groups usually comprises an alkali metal or an alkaline earth metal salt of a dicarboxylic acid containing sulfonate groups, or ester-forming derivatives thereof, preferably alkali metal salts of 5-sulfoisophthalic acid, or a mixture of these, particularly preferably the sodium salt.

According to one of the preferred embodiments, the acid component 1) comprises from 40 to 60 mol % of 1a), from 40 to 60 mol % of 1b), and from 0 to 2 mol % of 1c). According to another preferred embodiment, the acid component 1) comprises from 40 to 59.9 mol % of 1a), from 40 to 59.9 mol % of 1b), and from 0.1 to 1 mol % of 1c), in particular from 40 to 59.8 mol % of 1a), from 40 to 59.8 mol % of 1b), and from 0.2 to 0.5 mol % of 1c).

The diols 2) are generally selected among branched or linear alkanediols having from 2 to 12 carbon atoms, preferably from 4 to 6 carbon atoms, or among cycloalkanediols having from 5 to 10 carbon atoms.

Examples of suitable alkanediols are ethylene glycol, 1,2-propanediol, 1,3-propanediol, 1,2-butanediol, 1,4-butanediol, 1,5-pentanediol, 2,4-dimethyl-2-ethylhexane-1,3-diol, 2,2-dimethyl-1,3-propanediol, 2-ethyl-2-butyl-1,3-propanediol, 2-ethyl-2-isobutyl-1,3-propanediol, 2,2,4-trimethyl-1,6-hexanediol, in particular ethylene glycol, 1,3-propanediol, 1,4-butanediol, and 2,2-dimethyl-1,3-propanediol (neopentyl glycol); cyclopentanediol, 1,4-cyclohexanediol, 1,2-cyclohexanedimethanol, 1,3-cyclohexane-dimethanol, 1,4-cyclohexanedimethanol, or 2,2,4,4-tetramethyl-1,3-cyclobutanediol. Particular preference is given to 1,4-butanediol, in particular in combination with adipic acid as component a1), and 1,3-propanediol, in particular in combination with sebacic acid as component a1). Another advantage of 1,3-propanediol and 1,4-butanediol is that they are accessible in the form of renewable raw materials. It is also possible to use a mixture of various alkanediols.

As a function of whether an excess of acid end groups or of OH end groups is desired, an excess can be used either of component A or of component B. According to one preferred embodiment, the molar ratio of components A and B used can be in the range from 0.4:1 to 1.5:1, preferably in the range from 0.6:1 to 1.1:1.

The polyesters on which the polyester mixtures of the invention are based can comprise further components, alongside components 1) and 2).

The dihydroxy compounds 3a) used preferably comprise diethylene glycol, triethylene glycol, polyethylene glycol, polypropylene glycol, and polytetrahydrofuran (poly THF), particularly preferably diethylene glycol, triethylene glycol, and polyethylene glycol, and it is also possible here to use a mixture thereof, or to use compounds which have various variables n (see formula 1), an example being polyethylene glycol, which comprises propylene units (n=3), obtainable by way of example via polymerization using methods known per se, first of ethylene oxide, and then using propylene oxide, particular preference being given to a polymer based on polyethylene glycol having various variables n, where units formed from ethylene oxide predominate. The molar mass (Mₙ) of the polyethylene glycol is generally selected within the range from 250 to 8000 g/mol, preferably from 600 to 3000 g/mol.

According to one preferred embodiment, it is possible to use by way of example from 15 to 98 mol %, preferably from 60 to 99.5 mol %, of the diols 2) and from 0.2 to 85 mol %, preferably from 0.5 to 30 mol %, of the dihydroxy compounds 3a), based on the molar amount of 2) and 3a), for producing the semiaromatic polyesters.

In one preferred embodiment, the hydroxycarboxylic acid 3b) used comprises: glycolic acid, D-, L-, or D,L-lactic acid, 6-hydroxyhexanoic acid, cyclic derivatives thereof, such as glycolide (1,4-dioxane-2,5-dione), D- or L-dilactide (3,6-dimethyl-1,4-dioxane-2,5-dione), p-hydroxybenzoic acid, and also oligomers thereof and polymers, such as 3-polyhydroxybuteric acid, polyhydroxyvaleric acid, polylactide (obtainable for example in the form of NatureWorks® (Cargill)), or else a mixture of 3-polyhydroxybuttyric acid and polyhydroxyvaleric acid (the latter being obtainable as Biopol® from Zeneca), and it is particularly preferable to use the low-molecular-weight and cyclic derivatives thereof for producing semiaromatic polyesters.

Examples of amounts that can be used of the hydroxycarboxylic acids are from 0.01 to 50% by weight, preferably from 0.1 to 40% by weight, based on the amount of 1) and 2).

The amino-C₂-C₁₂ alkanol or amino-C₅-C₁₀ cycloalkanol (component 3c) used, where these include 4-aminomethylcyclohexanemethanol, preferably comprises amino-C₂-C₆ alkanols, such as 2-aminoethanol, 3-aminopropanol, 4-aminobutanol, 5-aminopentanol, 6-aminohexanol, or else amino-C₅-C₆ cycloalkanols, such as aminocyclopentanol and aminocyclohexanol, or a mixture thereof.

The diamino-C₁-C₈ alkane (component 3d) used preferably comprises diamino-C₄-C₆ alkanes, such as 1,4-diaminobutane, 1,5-diaminopentane, and 1,6-diaminohexane (hexamethylenediamine, “HMD”).

In one preferred embodiment, the materials used to produce the semiaromatic polyesters can comprise from 0.5 to 99.5 mol %, preferably from 0.5 to 50 mol %, of 3c), based on the molar amount of 2), and from 0 to 50 mol %, preferably from 0 to 35 mol %, of 3d), based on the molar amount of 2).

The 2,2′-bisoxazolines 3e) of the general formula III are generally obtainable via the process in Angew. Chem. Int. Edit., vol. 11 (1972), pp. 287-288. Particularly preferred bisoxazolines are those in which R¹ is a single bond, a (CH₂)_{z}-alkylene group, where z=2, 3, or 4, e.g. methylene, ethane-1,2-diyl, propane-1,3-diyl, propane-1,2-diyl, or a phenylene group. Particularly preferred bisoxazolines that may be mentioned are 2,2′-bis(2-oxazoline), bis(2-oxazolinyl)methane, 1,2-bis(2-oxazolinyl)ethane, 1,3-bis(2-oxazolinyl)propane or 1,4-bis(2-oxazolinyl)butane, in particular 1,4-bis(2-oxazolinyl)benzene, 1,2-bis(2-oxazolinyl)benzene or 1,3-bis(2-oxazolinyl)-benzene.

Production of the semiaromatic polyesters can by way of example use from 70 to 98 mol % of 2), up to 30 mol % of 3c), and from 0.5 to 30 mol % of 3d), and from 0.5 to 30 mol % of 3e), in each case based on the total of the molar amounts of components 2), 3c), 3d), and 3e). In another preferred embodiment, it is possible to use from 0.1 to 5% by weight, preferably from 0.2 to 4% by weight, of 3e), based on the total weight of 1) and 2).

The component 3f) used can comprise natural aminocarboxylic acids. Among these are valine, leucine, isoleucine, threonine, methionine, phenylalanine, tryptophane, lysine, alanine, arginine, aspartamic acid, cysteine, glutamic acid, glycine, histidine, proline, Serine, tryosine, asparagine, and glutamin.

Preferred aminocarboxylic acids of the general formulae IVa and IVb are those in which s is an integer from 1 to 1000 and t is an integer from 1 to 4, preferably 1 or 2, and T has been selected from the group of phenylene and —(CH₂)ᵤ—, where u is 1, 5, or 12.

3f) can moreover also be a polyoxazoline of the general formula V. However, 3f) can also be a mixture of various aminocarboxylic acids and/or polyoxazolines.

In one preferred embodiment, the amounts that can be used of 3f) are from 0.01 to 50% by weight, preferably from 0.1 to 40% by weight, based on the total amount of components 1) and 2).

Among further components which can optionally be used for producing the semi-aromatic polyesters are compounds 4a) which comprise at least three groups capable of ester formation.

The compounds 4a) preferably comprise from three to ten functional groups capable of forming ester bonds. Particularly preferred compounds 4a) have from three to six functional groups of this type within the molecule, in particular from three to six hydroxy groups and/or carboxy groups. Examples that may be mentioned are:

tartaric acid, citric acid, malic acid;
trimethylolpropane, trimethylolethane;
pentaerythritol;
polyethertriols;
glycerol;
trimesic acid;
trimellitic acid, trimelliticanhydride;
pyromellitic acid, pyromelliticdianhydride, and
hydroxyisophthalic acid.

The amounts used of the compounds 4a) are generally from 0.01 to 15 mol %, preferably from 0.05 to 10 mol %, particularly preferably from 0.1 to 4 mol %, based on component 1).

The component 4b) used comprises an, or a mixture of various, isocyanate(s). It is possible to use aromatic or aliphatic diisocyanates. However, it is also possible to use isocyanate of relatively high functionality.

For the purposes of the present invention, an aromatic diisocyanate 4b) is especially

tolylene 2,4-diisocyanate, tolylene 2,6-diisocyanate, diphenylmethane 2,2′-diisocyanate, diphenylmethane 2,4′-diisocyanate, diphenylmethane 4,4′-diisocyanate, naphthylene 1,5-diisocyanate, or xylylene diisocyanate.

Among these, particular preference is given to diphenylmethane 2,2′-, 2,4′- and 4,4′-diisocyanate as component 4b). The latter diisocyanates are generally used in the form of a mixture.

Tri(4-isocyanatophenyl)methane can also be used as trinuclear isocyanate 4b). Polynuclear aromatic diisocyanates are produced by way of example during production of mono- or binuclear diisocyanates.

Component 4b) can also comprise subordinate amounts of uretdione groups, e.g. up to 5% by weight, based on the total weight of component 4b), for example in order to cap the isocyanate groups.

For the purposes of the present invention, an aliphatic diisocyanate 4b) is especially a linear or branched alkylene diisocyanate or cycloalkylene diisocyanate having from 2 to 20 carbon atoms, preferably from 3 to 12 carbon atoms, e.g. hexamethylene 1,6-diisocyanate, isophorone diisocyanate, or methylene-bis(4-isocyanatocyclo-hexane). Particularly preferred aliphatic diisocyanates 4b) are hexamethylene 1,6-diisocyanate and isophorone diisocyanate.

Among the preferred isocyanurates are the aliphatic isocyanurates that derive from alkylene diisocyanates or from cycloalkylene diisocyanates having from 2 to 20 carbon atoms, preferably from 3 to 12 carbon atoms, e.g. isophorone diisocyanate or methylene-bis(4-isocyanatocyclohexane). The alkylene diisocyanates here can be either linear or branched. Particular preference is given to isocyanurates based on n-hexamethylene diisocyanate, for example cyclic trimers, pentamers, or higher oligomers of n-hexamethylene diisocyanate.

The amounts generally used of component 4b) are from 0.01 to 5 mol %, preferably from 0.05 to 4 mol %, particularly preferably from 0.1 to 4 mol %, based on the total of the molar amounts of 1) and 2).

The divinyl ethers 4c) used can generally comprise any of the divinyl ethers that are conventional and commercially available. It is preferable to use 1,4-butanediol divinyl ether, 1,6-hexanediol divinyl ether, or 1,4-cyclohexanedimethanol divinyl ether, or a mixture thereof.

The amounts preferably used of the divinyl ethers are from 0.01 to 5% by weight, in particular from 0.2 to 4% by weight, based on the total weight of 1) and 2).

Examples of preferred semiaromatic polyesters are based on the following components

1), 2), 4a)
1), 2), 4b)
1), 2), 4a), 4b)
1), 2), 4c)
1), 2), 3a)
1), 2), 3a), 4c)
1), 2), 3c), 3d)
1), 2), 3c), 3d), 3e)
1), 2), 4a), 3c), 3e)
1), 2), 3c), 4c)
1), 2), 3c), 4a)
1), 2), 3a), 3c), 4c)
1), 2), 3b)

Among these, particular preference is given to semiaromatic polyesters based on 1), 2), 4a), or 1), 2), 4b), or on 1), 2), 4a), 4b). In another preferred embodiment, the semi-aromatic polyesters are based on 1), 2), 3c), 3d), 3e), or 1), 2), 4a), 3c), 3e).

In one preferred embodiment, the melting point of at least one of the polyesters comprised in the plastics component A is lower than that of the polyesters B1 of the second plastics component B.

Preference is given, as thermoplastic polyester A1, to a random copolyester composed of terephthalic acid (from 10-40 mol %), 1,4-butanediol (50 mol %) and adipic acid or sebacic acid (from 10-40 mol %), where the entirety of the monomers is 100% by weight. Particular preference is given to a random copolyester composed of terephthalic acid (from 15-35 mol %), 1,4-butanediol (50 mol %), and adipic acid (from 15-35 mol %), where the entirety of the monomers is 100% by weight.

The homo- or copolyester A2 has preferably been selected from the group consisting of polylactide (PLA), polycaprolactone, polyhydroxyalkanoates, such as PHB or PHB/V, and polyester derived from aliphatic dicarboxylic acids and from aliphatic diols.

Advantage of the lower melting point is that incipient melting of the first plastics component A can give a particularly leakproof bond when the second component B is injected over the material.

The first plastics component A can also comprise one or more additives. The additives here are usually those selected from the group consisting of impact modifiers, flame retardants, nucleating agents, carbon black, pigments, colorants, mold-release agents, heat-aging stabilizers, antioxidants, processing stabilizers, lubricants and antiblocking agents, waxes, plasticizers, surfactants, antistatic agents, and antifogging agents. The proportion of the additives, based on the mass of plastics component A, is preferably in the range from 0 to 15% by weight.

The material can also comprise fibrous or particulate fillers. Suitable fibrous or particulate fillers can be inorganic or organic. Examples of suitable materials are glass fibers, carbon fibers, aramid fibers, kaolin, calcined kaolin, talc, chalk, silicates, mica, wollastonites, montmorillonites, cellulosic fibers, such as cotton, flax, hemp, nettle fibers, or the like, amorphous silica, and powdered quartz. Among the fibrous or particulate fillers, particular preference is given to the particulate fillers. Very particular preference is given to minerals and glass beads, in particular glass beads. The proportion of fibrous or particulate fillers, based on the mass of plastics component A, is preferably in the range from 0 to 50% by weight. If the first plastics component A comprises glass beads, the proportion of the glass beads is preferably in the range from 0.1 to 40% by weight, based on the total weight of the first plastics component A.

To improve compatibility with the first plastics component A, the surface of the fillers can by way of example have been treated with an organic compound or with a silane compound.

Examples of suitable impact modifiers for the first plastics component A are copolymers composed of at least two monomer units selected from ethylene, propylene, butadiene, isobutene, isoprene, chloroprene, vinyl acetate, styrene, acrylonitrile, and acrylates and, respectively, methacrylates having from 1 to 18 carbon atoms in the alcohol component. Suitable impact modifiers are known by way of example from WO-A 2007/009930.

The first plastics component A can comprise amounts of from 0 to 50% by weight, based on the total weight of the first plastics component A, of flame retardants. Examples of suitable flame retardants are halogen-containing flame retardants, halogen-free flame retardants, melamine-cyanurate-based flame retardants, phosphorus-containing flame retardants, and flame retardants comprising expanded graphite.

According to the invention, plastics component A comprises at least one compatibilizer A3. The proportion of the at least one compatibilizer is preferably in the range from 0.05 to 5% by weight, in particular in the range from 0.1 to 3% by weight, in each case based on the total weight of plastics component A.

The compatibilizers used can either improve the bonding of component A2 into the matrix of the semiaromatic polyester A1 or act as adhesion promoters between the first plastics component A and the second plastics component B. Examples of suitable compatibilizers are styrene (co)polymers grafted with glycidyl methacrylates, for example those described on pages 17-25 in Macromol. Symp. 2006, 233. Other suitable materials are styrene (co)polymers grafted with isocyanate groups, poly[methylene(phenylene isocyanate)], bisoxazolines, styrene copolymers grafted with oxazoline groups, or styrene copolymers grafted with maleic anhydride. Particularly suitable materials are styrene copolymers equipped with epoxy functionalities, with a proportion of methacrylic acid. Preference is given to random, epoxy-functionalized styrene-acrylic acid copolymers with a molar mass M_{w} of from 3000 to 8500 g/mol and functionalization by more than two epoxy groups per molecule chain. Particular preference is given to random, epoxy-functionalized styrene-acrylic acid copolymer with a molar mass M_{w} of from 5000 to 7000 g/mol and functionalization by more than four epoxy groups per molecule chain.

The at least one semicrystalline, thermoplastic polyester B1, based on aromatic dicarboxylic acids and on aliphatic or aromatic dihydroxy compounds, of the second plastics component B is preferably a polyalkylene terephthalate or a mixture composed of at least two different polyalkylene terephthalates. The at least one polyalkylene terephthalate here preferably has from 2 to 10 carbon atoms in the alcohol moiety. Polyalkylene terephthalates of this type are known per se and are described in the literature. Their main chain comprises an aromatic ring, deriving from the aromatic dicarboxylic acid. The aromatic ring can also have substitution, e.g. by halogen, such as chlorine or bromine, or by C₁-C₄-alkyl groups, such as methyl, ethyl, isopropyl, n-propyl, or n-butyl, isobutyl, or tert-butyl groups.

The polyalkylene terephthalates can be produced via reaction of aromatic dicarboxylic acids, or their esters or other ester-forming derivatives, with aliphatic dihydroxy compounds, in a manner known per se.

Preferred dicarboxylic acids are 2,6-naphthalenedicarboxylic acid, terephthalic acid, and isophthalic acid, or a mixture of these. Up to 30 mol %, but of the aromatic dicarboxylic acids, preferably not more than 10 mol %, can be replaced by aliphatic or cycloaliphatic dicarboxylic acids, such as adipic acid, azelaic acid, sebacic acid, dodecanedioic acids, and/or cyclohexanedicarboxylic acids.

Among the aliphatic dihydroxy compounds, preference is given to diols having from 2 to 6 carbon atoms, in particular 1,2-ethanediol, 1,3-propanediol, 1,4-butanediol, 1,6-hexanediol, 1,4-hexanediol, 1,4-cyclohexanediol, 1,4-cyclohexanedimethanol, neopentyl glycol, or a mixture of these.

It is particularly preferable that the semicrystalline thermoplastic polyester B1 that takes the form of polyalkylene terephthalate in the second plastics component B is a polyethylene terephthalate, polytrimethylene terephthalate, polybutylene terephthalate, or a mixture composed of at least two of said polyalkylene terephthalates.

It is very particularly preferable that the semicrystalline thermoplastic polyester B1 that takes the form of polyalkylene terephthalate in the second plastics component B is a polybutylene terephthalate, or a mixture composed of polybutylene terephthalate (from 60 to 90% by weight) and polyethylene terephthalate (from 10 to 40% by weight), where the entirety of PBT and PET is 100% by weight.

The intrinsic viscosity of the polyesters A2 and B1 is generally in the range from 50 to 220 ml/g, preferably in the range from 80 to 160 ml/g (measured in 0.5% strength by weight solution in a phenol/o-dichlorobenzene mixture (ratio by weight 1:1) at 250° C. to ISO 1628).

Particular preference is given to polyesters A2 and B1 which have carboxy end group content up to 100 meq/kg of polyester, preferably up to 50 meq/kg of polyester, and in particular up to 40 meq/kg of polyester. Polyesters of this type can by way of example be produced by the process described in DE-A 44 01 055. The carboxy end group content is usually determined by titration methods, such as potentiometry.

It is moreover advantageous to use polyethylene terephthalate recyclates (also termed scrap PET), if appropriate in a mixture with polyalkylene terephthalates, such as polybutylene terephthalate.

Recyclates are generally the materials known as post-industrial recyclate or post-consumer recyclate.

Post-industrial recyclate is production waste from the polycondensation reaction or from processing, for example sprues from injection-molding processes, start-up product from injection-molding processes or extrusion processes, or edge-cuts from extruded sheets or foils.

Post-consumer recyclate is usually plastics items collected and recycled by the end consumer after use. In quantitative terms, by far the most important items are blow-molded bottles composed of polyethylene terephthalate, used by way of example for mineral water, soft drinks, and juices.

Both types of recyclate can take the form either of regrind or of pellets. In the latter case, the crude recyclates are first separated and purified and then melted and pelletized in an extruder. This mostly facilitates handling, free-flowing properties, and ease of metering for further processing steps.

Recyclates can be used either in the form of pellets or in the form of regrind, and the maximum edge length here should be 10 mm, preferably 8 mm.

Because of the hydrolytic cleavage of polyesters during processing, e.g. caused by traces of moisture, it is preferable to predry the recyclate. The residual moisture content after drying is preferably less than 0.2%, in particular less than 0.05%.

Another group which may be mentioned is that of fully aromatic polyesters which derive from aromatic dicarboxylic acids and from aromatic dihydroxy compounds.

Suitable aromatic dicarboxylic acids are the compounds already described for the polyalkylene terephthalates. The mixtures preferably used are composed of from 5 to 100 mol % of isophthalic acid and from 0 to 95 mol % of terephthalic acid, in particular mixtures of from about 50 to about 80% of terephthalic acid and from 20 to about 50% of isophthalic acid.

The aromatic dihydroxy compounds preferably have the general formula

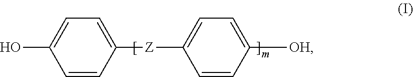

where Z is an alkylene or cycloalkylene group having up to 8 carbon atoms, an arylene group having up to 12 carbon atoms, a carbonyl group, a sulfonyl group, an oxygen or sulfur atom, or a chemical bond, and m is from 0 to 2. The phenylene groups of the dihydroxy compounds may also have substitution by C₁-C₈-alkyl or -alkoxy groups and fluorine, chlorine or bromine.

Examples of parent compounds are dihydroxybiphenyl, di(hydroxyphenyl)alkane, di(hydroxyphenyl)cycloalkane, di(hydroxyphenyl) sulfide, di(hydroxyphenyl)ether, di(hydroxyphenyl) ketone, di(hydroxyphenyl) sulfoxide, α,α′-di(hydroxyphenyl)-dialkylbenzene, di(hydroxyphenyl)sulfone, di(hydroxybenzoyl)benzene, resorcinol and hydroquinone, and also the ring-alkylated and ring-halogenated derivatives of these. Among these, preference is given to 4,4′-dihydroxydiphenyl, 2,4-di(4′-hydroxyphenyl)-2-methylbutane, α,α′-di(4-hydroxyphenyl)-p-diisopropylbenzene, 2,2-di(3′-methyl-4′-hydroxyphenyl)propane, and 2,2-di(3′-chloro-4′-hydroxyphenyl)propane, and in particular to 2,2-di(4′-hydroxyphenyl)propane, 2,2-di(3′,5-dichlorodihydroxyphenyl)-propane, 1,1-di(4′-hydroxyphenyl)cyclohexane, 3,4′-dihydroxybenzophenone, 4,4′-dihydroxydiphenyl sulfone and 2,2-di(3′,5′-dimethyl-4′-hydroxyphenyl)propane and mixtures thereof.

It is, of course, also possible to use mixtures of polyalkylene terephthalates and fully aromatic polyesters. These generally comprise from 20 to 98% by weight of the polyalkylene terephthalate and from 2 to 80% by weight of the fully aromatic polyester. It is also possible to use polyester block copolymers, such as copolyetheresters. Products of this type are known per se and are described in the literature, e.g. in U.S. Pat. No. 3,651,014. Corresponding products are also available commercially, e.g. Hytrel® (DuPont).

Mixtures of polyalkylene terephthalates B1 with styrene copolymers B2 can likewise be used. These preferably comprise from 60 to 90% by weight of polyalkylene terephthalate and from 10 to 40% by weight of the styrene copolymer. Particular preference is given to mixtures with from 60 to 80% by weight of polyalkylene terephthalate and from 20 to 40% by weight of styrene copolymer.

If the second plastics component B comprises at least one thermoplastic styrene (co)polymer B2, this has preferably been selected from the group consisting of acrylonitrile-styrene-acrylate (ASA), acrylonitrile-butadiene-styrene copolymers (ABS), styrene-acrylonitrile copolymers (SAN), and mixtures thereof.

One preferred embodiment comprises, as styrene copolymer B2, a styrene-acrylonitrile-acrylic acid copolymer (ASA) having the following constitution: from 20 to 40% by weight of styrene, from 20 to 40% by weight of acrylonitrile, and from 20 to 40% by weight of acrylic acid, where the entirety of the individual monomers is 100% by weight.

In one particularly preferred embodiment, the polyalkylene terephthalate B1 is polybutylene terephthalate and the styrene copolymer B2 is a styrene-acrylonitrile-acrylic acid copolymer (ASA) having the following constitution: from 20 to 40% by weight of styrene, from 20 to 40% by weight of acrylonitrile, and from 20 to 40% by weight of acrylic acid, where the entirety of the individual monomers is 100% by weight. The proportion of B1 is from 60 to 80% by weight and the proportion of B2 is from 20 to 40% by weight, and the total of the proportions is 100% by weight, based on the total weight of the plastic of polymer component B.

The second plastics component B can also comprise, alongside the at least one semicrystalline, thermoplastic polyester B1 and, if appropriate, the at least one thermoplastic styrene (co)polymer B2, one or more additives. The additives here are those selected from the group consisting of fibrous or particulate fillers, impact modifiers, flame retardants, nucleating agents, carbon black, pigments, colorants, mold-release agents, heat-aging stabilizers, antioxidants, processing stabilizers, and compatibilizers.

Examples of suitable fibrous or particulate fillers are carbon fibers, glass fibers, glass beads, amorphous silica, asbestos, calcium silicate, calcium metasilicate, magnesium carbonate, calcium carbonate, kaolin, chalk, powdered quartz, mica, barium sulfate, and feldspar. The preferred amounts of the fillers used here are from 0.1 to 50% by weight, particularly from 10 to 40% by weight. Preference is given to fibrous fillers and among these preference is in particular given to glass fibers. The proportion of the fillers here is based on the total weight of the second plastics component B.

To improve compatibility, the surface of the fillers can have been treated with an organic compound or with a silane compound.

Flame retardants which can be comprised in the second plastics component B are preferably the same as those that can also be comprised in the first plastics component A.

Alongside the additives mentioned, other materials that can also be comprised are stabilizers, oxidation retarders, agents to counteract decomposition by heat and decomposition due to UV radiation, lubricants and mold-release agents, colorants, such as dyes and pigments (also carbon blacks), nucleating agents, plasticizers, etc. The material can also comprise from 0 to 2% by weight, based on the total weight of the second plastics component B, of fluorine-containing ethylene polymers.

An example of the component is the type of plastics part used in electrical engineering, a mechatronic component, or a plastics casing with plug-in contacts.

An example of the insert part enclosed by the plastics jacketing is a stamped grid. In that case, the component can be used for example as plug connector. The insert part can moreover be a wire, a round conductor, a flat conductor, a flexible foil, or a printed circuit board.

If the component is used in the automobile industry sector, the insert part can, for example, also be a retaining strap, a door latch, a lock, a threaded bush, an antifriction bearing, a panel, a wire for stabilizers, or a component composed of diecast zinc or diecast aluminum for a door-securing unit. It is moreover also possible that the component is a blade for a knife, for scissors, for a scalpel, or else for a screwdriver.

The insert part has preferably been manufactured from a metal. Examples of suitable metals from which the insert part has been manufactured are copper and copper-containing alloys, such as CuSn6, CuSn0,15, CuBe, CuFe, CuZn37, CuSn4Zn6Pb3-C-GC (gunmetal) or CuZn39Pb3 (brass), aluminum and aluminum-containing alloys, such as AlSi12Cu1, AlSi10Mg, titanium, stainless steel, lead-free metals, and metal alloys, or materials with a tin coating.

The invention further provides a process for the production of a component comprising an insert part and plastics jacketing composed of at least two plastics components, where the process comprises the following steps:
(a) sheathing of an insert part with a first plastics component A, where the first plastics component A is composed of:
   A1: from 5 to 80% by weight, based on the total weight of components A1 and A2, of at least one polyester based on aliphatic and aromatic dicarboxylic acids and on aliphatic dihydroxy compounds;
   A2: from 20 to 95% by weight, based on the total weight of components A1 and A2, of at least one homo- or copolyester selected from the group consisting of polylactide (PLA), polycaprolactone, polyhydroxyalkanoates (e.g. PHB or PHB/V), and polyester derived from aliphatic dicarboxylic acids and from aliphatic diols;
   A3: from 0.05 to 15% by weight, based on the total weight of components A1 and A2, a) of a copolymer which contains epoxy groups and which is based on styrene, on acrylate, and/or on methacrylate, b) of a bisphenol A epoxide, or c) of a fatty acid amide or fatty acid ester, or natural oil containing epoxy groups; and
(b) molding of exterior sheathing composed of a second plastics component B, where the second plastics component B is composed of:
   B1: from 50 to 100% by weight of at least one semicrystalline, thermoplastic polyester based on aromatic dicarboxylic acids and on aliphatic or aromatic dihydroxy compounds and
   B2: from 0 to 50% by weight of at least one thermoplastic styrene (co)polymer,
   in each case based on the polymer content of the second plastics component B,
      where either the insert part is first sheathed with the first plastics component A and then the second plastics component B is applied or the exterior sheathing B is first molded, and then the first plastics component A is charged to a cavity between the exterior sheathing composed of the second plastics component B and the insert part, in order to form the sheathing of the insert part.

Among the particularly preferred semiaromatic polyesters are polyesters which comprise, as essential components
1) an acid component composed of
   1a) from 30 to 99 mol % of at least one aliphatic or at least one cycloaliphatic dicarboxylic acid, or ester-forming derivatives thereof, or a mixture thereof,
   1b) from 1 to 70 mol % of at least one aromatic dicarboxylic acid, or ester-forming derivative thereof, or a mixture thereof, and
   1c) from 0 to 5 mol % of a compound containing sulfonate groups,
2) a diol component selected from at least one C₂-C₁₂ alkanediol, from at least one C₅-C₁₀ cycloalkanediol, or a mixture thereof,
   and, if appropriate, also comprising one or more components selected from
3) a component selected from
   3a) at least one dihydroxy compound of the formula I comprising ether functions

HO—[(CH₂)ₙ—O]ₘ—H (I)
in which n is 2, 3, or 4, and m is an integer from 2 to 250,
3b) at least one hydroxycarboxylic acid of the formula IIa or IIb

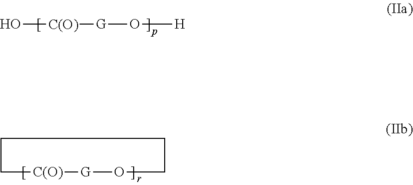

in which p is an integer from 1 to 1500 and r is an integer from 1 to 4, and G is a radical selected from the group consisting of phenylene, —(CH₂)_{q}—, where q is an integer from 1 to 5, —C(R)H— and —C(R)HCH₂, where R is methyl or ethyl,
3c) at least one amino-C₂-C₁₂ alkanol or at least one amino-C₅-C₁₀ cycloalkanol, or a mixture thereof,
3d) at least one diamino-C₁-C₈ alkane,
3e) at least one 2,2′-bisoxazoline of the general formula III

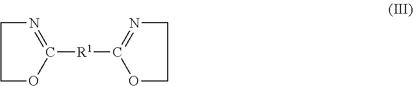

where R¹ is a single bond, a (CH₂)_{z}-alkylene group, where z=2, 3, or 4, or a phenylene group,
3f) at least one aminocarboxylic acid selected from the group consisting of the natural amino acids, polyamides obtainable via polycondensation of a dicarboxylic acid having from 4 to 6 carbon atoms and of a diamine having from 4 to 10 carbon atoms, compounds of the formulae IVa and IVb

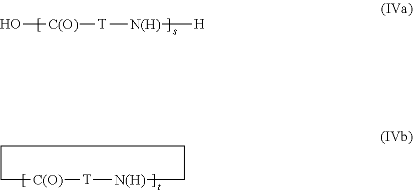

in which s is an integer from 1 to 1500 and t is an integer from 1 to 4, and T is a radical selected from the group consisting of phenylene, —(CH₂)ᵤ—, where u is an integer from 1 to 12, —C(R²)H— and —C(R²)HCH₂, where R² is methyl or ethyl,
and from polyoxazolines having the repeat unit V

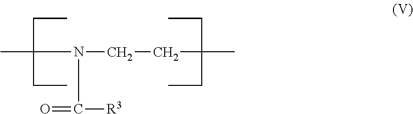

in which R³ is hydrogen, C₁-C₆-alkyl, C₅-C₈-cycloalkyl, phenyl which is unsubstituted or which has up to three substituents that are C₁-C₄-alkyl groups, or is tetrahydrofuryl,
or a mixture of 3a) to 3f),
   and
4) a component selected from
   4a) at least one compound having at least three groups capable of ester formation,
   4b) at least one isocyanate,
   4c) at least one divinyl ether,
   or a mixture of 4a) to 4c).

In one preferred embodiment, the acid component 1) of the semiaromatic polyesters comprises from 30 to 70 mol %, in particular from 40 to 60 mol %, of 1a) and from 30 to 70 mol %, in particular from 40 to 60 mol %, of 1b).

In one preferred embodiment, the hydroxycarboxylic acid 3b) used comprises: glycolic acid, D-, L-, or D,L-lactic acid, 6-hydroxyhexanoic acid, cyclic derivatives thereof, such as glycolide (1,4-dioxane-2,5-dione), D- or L-dilactide (3,6-dimethyl-1,4-dioxane-2,5-dione), p-hydroxybenzoic acid, and also oligomers thereof and polymers, such as 3-polyhydroxybuteric acid, polyhydroxyvaleric acid, polylactide (obtainable for example in the form of NatureWorks® (Cargill)), or else a mixture of 3-polyhydroxybuttyric acid and polyhydroxyvaleric acid (the latter being obtainable as Biopol® from Zeneca), and it is particularly preferable to use the low-molecular-weight and cyclic derivatives thereof for producing semiaromatic polyesters.

Examples of amounts that can be used of the hydroxycarboxylic acids are from 0.01 to 50% by weight, preferably from 0.1 to 40% by weight, based on the amount of 1) and 2).

Plastics component A can also, as described above, comprise additives and/or fibrous and/or particulate fillers.

In one preferred embodiment, an injection-molding process is used for the sheathing of the insert part with the first plastics component A in a step (a). For this, the insert part is placed in an injection mold. Once the insert part has been placed, the mold is closed and the plastics molding composition is injected into the mold. The plastics molding composition at least partially sheaths the insert part and forms an adhesive bond with the insert part. The result is a leakproof bond between the insert part and the plastics component A. Injection of the plastics molding composition here generally takes place at the pressures conventional in injection molding. However, if, for example, non-uniform injection around the insert part can cause it to deform, it is preferable that the maximum pressure at which the injection of component A takes place in the mold is less than 900 bar, more preferably less than 600 bar. The low injection pressure avoids deformation of the insert part when the material is injected around it. Once the material has been injected around the insert part, the first plastics component A hardens and becomes solid. A further advantage of injecting the first plastics component A around the insert part is that the insert part is stabilized by said plastics sheathing.

A very wide variety of shapes can be realized when the insert part is sheathed by the first plastics component A. By way of example, it is possible to realize a rectangular, rhombic, pentagonal, octagonal, circular, or elliptical cross section. If the plastics sheathing composed of the first plastics component A has corners, these can also be rounded corners.

Junctions between the surfaces of the sheathing composed of the first plastics component A can be obtuse-angled, acute-angled, or rounded junctions. There can also be distinct melt lips, i.e. thin protruding regions composed of the first plastics component A. These are then melted and deformed when the second plastics component B is injected over the material. A coherent bond is thus produced.

There can also be protruding regions designed on the material injected around the insert part and composed of the first plastics component A. By way of example, the first plastics component A can enclose the insert part with a cross section in the shape of a double T. An interlock bond can be achieved via the protruding regions when the first plastics component A is injected around the material in this way. Since injection of the second plastics component B over the first plastics component A generally causes incipient melting of the latter, the shape of the material previously injected, composed of the first plastics component A, can generally change if the processing temperature of the second plastics component B is above the melting point or the softening point of the first plastics component A. It is also possible that the material previously injected, composed of the first plastics component A, is deformed via the pressure of the injected melt when the second plastics component B is injected around the material. By way of example, sharp edges of the material previously injected, composed of the first plastics component A, can be rounded.

Once the insert part has been sheathed with the first plastics component A, the insert part thus sheathed is sheathed with the second plastics component B. The sheathing with the second plastics component B preferably likewise takes place via an injection-molding process. The injection-molding process here is generally carried out with the pressures conventional in injection molding. If the plastics molding composition has been injected with low injection pressure, the pressure in the mold here is generally higher than the maximum pressure in the mold in step (a). During injection of the second plastics component B, the surface of hardened first plastics component A preferably undergoes incipient melting, thus producing particularly good adhesion between the first plastics component A and the second plastics component B.

The sheathing of the insert part with the first plastics component A in step (a) and the molding of the exterior sheathing composed of the second plastics component B in step (b) can take place in the same injection mold. For this, it is necessary that the injection mold initially encloses a cavity which corresponds to the shape of the insert part with the sheathing composed of the first plastics component A. The mold must then open in such a way that the unoccupied shape corresponds to the shape of the finished component. The person skilled in the art is aware of appropriate molds.

However, as an alternative it is also possible that the sheathing of the insert part with the first plastics component A in step (a) takes place in a first mold and that the molding of the exterior sheathing composed of the second plastics component B in step (b) takes place in a second mold. In that case it is necessary that the insert part sheathed with the first plastics component A is removed from the first mold and placed in the second mold prior to injecting of the second plastics component B around the material. If the intention is to avoid deformation of the sheathing of the insert part composed of the first plastics component A, it is necessary that the first plastics component A exhibits sufficient mechanical resistance to the approaching flow of melt of the second plastics component B. This requires sufficient stiffness and strength, and these are dependent on the degree of hardening of the first plastics component A and on the injection pressure of the second plastics component B. In order to avoid the necessity for cleaning of the injection-molding machine after every injection procedure, in order to change the material, it is preferable that two different injection-molding machines or plastifying units are used for the first plastics component A and the second plastics component B. If the sheathing in step (a) and the molding of the exterior sheathing in step (b) take place with the same mold, it is possible that the mold has simultaneous connection to both injection-molding machines. An alternative possibility is to begin by connecting the mold to the injection-molding machine which injects the first plastics component A and then to connect the mold to the injection-molding machine that injects the second plastics component B around the insert part with the sheathing composed of the first plastics component A. Examples of conventional injection-molding machines used for this purpose are injection-molding machines with turntable mold. These have, by way of example, an opposite arrangement of the cylinders, and in each case the mold is rotated toward the cylinder from which the next material will be injected. If two different molds are used, each of these preferably has connection to an injection-molding machine. A suitable injection-molding machine here is any desired injection-molding machine known to the person skilled in the art.

It is possible that, in step (b), the second plastics component B sheaths only parts of the insert part sheathed with the first plastics component A. In that case it is preferable that the regions around which the second plastics component B is injected are those having an external surface, since sheathing with the second plastics component B ensures that the molding has dimensional stability. Another possible alternative is, of course, that the second plastics component B is injected around the entire insert part with the sheathing composed of the first plastics component A.

In that version of the process which comprises first molding the exterior sheathing composed of the second plastics component B, where regions of the insert part are not sheathed, and, in a second step, sheathing the unsheathed regions of the insert part with the first plastics component A, the preferred method of sheathing of the insert part with the second plastics component B is that said component sheaths the insert part in those regions in which external surfaces are present. The regions onto which the first plastics component A is cast preferably have no outward-facing areas. This method ensures that the resultant component has geometric and dimensional stability. The sheathing of the insert part with the second plastics component B preferably takes place via an injection-molding process. For this, the insert part is placed in an injection mold, and the second plastics component B is then injected around the same. To avoid penetration of the second plastics component B into the regions intended to be excluded, the mold is in contact with the insert part in those regions. Once the insert part has been sheathed with the second plastics component B, the regions that are intended for sheathing with the first plastics component A are rendered accessible. For this, it is possible either to have movable parts provided in the mold which initially form the exclusions and then render the exclusions accessible so that they can be cast by the first plastics component A, or to remove, from the mold, the insert part around which the second plastics component B has been injected, and to place it in a second mold in which the regions intended for sheathing with the first plastics component A have been rendered available. The sheathing with the first plastics component A preferably likewise takes place via an injection-molding process. This is generally carried out with the pressures conventional in injection-molding processes. If, for example, non-uniform injection around the insert part can cause it to deform, the injection-molding process for the first plastics component A is preferably carried out at a lower pressure than the injection-molding process used to inject the second plastics component B around the insert part. The pressure for the sheathing of the insert part with the first plastics component A is then preferably below 900 bar, with preference below 600 bar. The preferred method of achieving a leakproof bond between the first plastics component A and the second plastics component B is that the melt of the first plastics component A causes incipient melting on the surface of the plastics component B, so that, for example, interdiffusion produces particularly good adhesion between the first plastics component A and the second plastics component B. A further possibility is chemical and/or mechanical bonding between the first plastics component A and the second plastics component B. A chemical bond can be produced, for example, via reaction of the polymer components of the first plastics component A and of the second plastics component B, for example by forming covalent bonds between the first plastics component A, or one component of the first plastics component A, and the second plastics component B, or one component of the second plastics component B. Another possibility always available is to design the process in such a way as to give not only good adhesion but also an interlock bond between the first plastics component A and the second plastics component B.

The melt temperature of the first plastics component A during the first injection of material around the insert part is preferably in the region of the usual temperature for processing of the underlying polymer by injection molding. If the first plastics component A is a mixture composed of two polymers, the melt temperature is selected to be sufficiently high that both components are liquid.

A higher processing temperature leads to a more free-flowing melt which can provide better wetting of the surface of the insert part, thus permitting achievement of higher bond strength between the material of the insert part and of the first plastics component A. However, an excessive melt temperature can lead to thermal degradation of the first plastics component A or of one of its components A1 or A2.

When the second plastics component B is then injected over the component, the melt temperature of the second plastics component B is preferably in the region of the usual temperature for processing of the underlying polymer by injection molding. If the second plastics component B is a mixture composed of two polymers, the melt temperature is selected to be sufficiently high that both components are liquid.

A higher processing temperature leads to a more free-flowing melt which can provide better wetting and/or incipient melting of the surface of the sheathing composed of the first plastics component A, thus permitting achievement of higher bond strength between the second plastics component B and the first plastics component A. As a function of the thermodynamic compatibility of the two components, a boundary layer of varying thickness can arise, improving leakproof properties via interdiffusion, and providing a coherent bond between plastics components A and the second plastics component B. The melt temperature of the second plastics component B is preferably not set so high that the sheathing composed of the first plastics component A is entirely melted and ablated. It is also preferable that the injection pressure for the second plastics component B is selected in such a way that the sheathing composed of the first plastics component A is not excessively deformed, or, in the worst case, ablated.

The component of the invention is by way of example the type of plastics part used in electrical engineering. It is also possible that the component is a mechatronic component or a plastics casing with plug-in contacts. Components of this type are used by way of example as sensors, for example as oil sensors, wheel-rotation-rate sensors, pressure sensors, etc., as electronics casings, as control casings, for example in the ABS sector, the ESP sector, the transmission-system sector, or the airbag sector, or in the engine-control system of motor vehicles. The components can also be used by way of example as window-lifter modules or for the headlamp control system. The components of the invention can also be used outside of the automobile industry by way of example as sensors, as fill-level indicators, or as pipeline units. Examples of another suitable use of the components of the invention are electronics components in household devices. Examples of suitable components are relays, coil formers, switch parts, magnetic valves, electrical hand tools, plug devices, or plug connectors.

A feature of the component of the invention, composed of the insert part with the sheathing composed of the first plastics component A and the exterior sheathing composed of the second plastics component B, is that it is leakproof along both interfaces, i.e. the interface between insert part and sheathing composed of the first plastics component A and the interface between the first plastics component A and the second plastics component B. A leakproof bond here means that the leakage rate in a test under changing climatic conditions using at least 200 cycles in which the component to be tested is subjected to an alternating temperature of −40° C. and +150° C. is smaller than 0.5 cm³/min. The leakage rate is usually determined by a pressure-difference method with a test pressure of 0.5 bar.

### EXAMPLES

Test specimens are produced from an insert part composed of CuSn6 sheathed with a first plastics component A and with a second plastics component B.

To produce the test specimens, a punching die is first used to punch the insert part from strips of CuSn6. The insert part has a rectangular frame, and there is also a central fillet here connecting the opposite short sides of the frame. The length of the insert part produced is 30 mm, its width is 10.5 mm, and its height is 0.5 mm. The length of the grooves between the exterior fillets of the frame and the central fillet is 25 mm, and the width of the grooves is 3 mm.

After the punching process, the punched parts are cleaned with acetone to remove oils and impurities. An injection-molding machine with screw diameter 18 mm is used to produce the test specimens (Allrounder 270S from Arburg). The clamping force of the mold is 500 kN, and the injection pressure is 1500 bar. Material in the shape of a parallelepiped is injected around the central region of the insert part with the three fillets, whereupon the sheathing composed of the second plastics component B completely encloses the first plastics component A. The length of the sheathing composed of the first plastics component A is 15 mm, its width is 4.5 mm, and its thickness is 1.5 mm, while the length of the sheathing composed of the second plastics component B, which completely encloses the first plastics component A, is 20 mm, its width is 13 mm, and its thickness is 4.5 mm. The injection of the first plastics component A onto the insert part and the injection of the second plastics component B onto the insert part sheathed with the first plastics component A take place approximately at the mold-parting line.

In order to test the materials, the components with the sheathing composed of the first plastics component A and with the sheathing composed of the second plastics component B are subjected to temperature-shock stressing, using up to 500 cycles. The following schedule applied here for each temperature-shock cycle: 15 minutes of storage at 150° C., temperature change to −40° C. within 10 seconds, 15 minutes of storage at −40° C., temperature change to 150° C. within 10 seconds. The temperature-shock treatment took place in a VT 7030S2 temperature-shock cabinet from Vötsch. Leakproof properties were measured by means of a differential-pressure method prior to stressing, and also after 100, 200, and, if appropriate, 500 cycles.

For the differential-pressure test, two volumes are subjected to the same pressure, a test volume and a control volume. If the test volume is not leakproof, a pressure difference arises and can be directly measured. As an alternative, the pressure drop per unit of time can be measured. In the present embodiment, the exterior periphery of the test specimen was tightly clamped into a holder and pressure was applied to the underside of the test specimen. The system was sealed by a rubber sealing ring. A blind trial using a solid test specimen composed of component B1 was used to demonstrate that the only leaks that cause leakage from the test volume are those arising in the direction of the insert part, between insert part and the sheathing composed of the first plastics component A, or between the sheathing composed of the first plastics component A and the sheathing composed of the second plastics component B. The test medium used was air. The test volume Vₜₑₛₜ was 36 ml. The time required to fill the volumes with a test pressure of 0.5 bar was 5 seconds. After 10 seconds of standing time, the pressure drop was measured for Δtₜₑₛₜ=5 seconds. The volumes were then evacuated within 2 seconds. The differential pressure drop was used in the Boyle-Marriotte equation to calculate the leakage rates:

$${Q}_{leak} [ ml \text{/} min ] = \frac{{V}_{test} \cdot Δ p}{Δ {t}_{test} \cdot 1000 mbar}$$

Table 1 collates the results. Components A1-4 are various overall constitutions of component A, rather than the individual constituents of the same.

TABLE 1
Experimental results

| | | Inv. | Comp. | Comp. | Comp. |
|---|---|---|---|---|---|
| | | ex. 1 | ex. 1 | ex. 2 | ex. 3 |
| A1 | [% by weight] | 100 | | | |
| A2 | [% by weight] | | 100 | | |
| A3 | [% by weight] | | | 100 | |
| A4 | [% by weight] | | | | 100 |
| B1 | [% by weight] | 100 | 100 | 100 | 100 |
| Leakage | [ml/min] | 0.7 | not | 1.1 | 0.4 |
| rate after | | | measurable | | |
| injection | | | | | |
| molding | | | | | |
| SD | [ml/min] | 0.7 | not | 0.3 | 0.2 |
| | | | measurable | | |
| Leakage | [ml/min] | 0.6 | not | no data | 4.0 |
| rate after | | | measurable | | |
| 100 cycles | | | | | |
| SD | [ml/min] | 0.6 | not | no data | 0.8 |
| | | | measurable | | |
| Leakage | [ml/min] | 0.1 | not | no data | no data |
| rate after | | | measurable | | |
| 500 cycles | | | | | |
| SD | [ml/min] | 0.3 | not | no data | no data |
| | | | measurable | | |

Component A1 is a blend composed of 55% of a random aliphatic-aromatic copolyester produced from terephthalic acid (25%), adipic acid (25%), and butanediol (45%), with 45% of polylactide (PLA). Said blend has two melting points, from 110 to 120° C. and from 140 to 155, determined by DSC, a Vicat softening point (VSP A/50) of 68° C. measured to ISO 306:2004, a Shore D hardness of 59 measured to ISO 868, and modulus of elasticity of 750 MPa, determined to ISO 527 on blown films of thickness 50 μm.

Component A2 is a random copolyester composed of terephthalic acid (25 mol %), 1,4-butanediol (50 mol %), and adipic acid (25 mol %), with melting point from 110 to 120° C. (DSC measurement to ISO 11357-3) and Shore D hardness 32, determined to ISO 868. The Vicat softening point is 91° C., measured to EN ISO 306:2004.

Component A3 is a polybutylene terephthalate with intrinsic viscosity 130 ml/g, measured in 0.5% solution in phenol/o-dichlorobenzene (1:1) to ISO 1628. The modulus of elasticity of the material is 2500 MPa (ISO 527-2) and its melting range is from 220 to 225° C. (DSC measurement to ISO 11357-3).

Component A4 is a polybutylene terephthalate with 30% by weight of solid glass beads. The intrinsic viscosity of the material is 113 ml/g, measured in 0.5% solution in phenol/o-dichlorobenzene (1:1) to ISO 1628, its modulus of elasticity is 4000 MPa (ISO 527-2), and its melting range is from 220 to 225° C. (DSC measurement to ISO 11357-3).

Component B is a polybutylene terephthalate with 30% by weight of glass fibers with intrinsic viscosity 102 g/ml, measured in 0.5% solution in phenol/o-dichlorobenzene (1:1) to ISO 1628. It also comprises 0.1% by weight of a furnace black with average particle size from 10 to 35 nm (CILAS) and with BET surface area of from 110 to 120 m²/g (ISO 9277), and also 0.5% by weight of pentaerythritol tetrastearate as lubricant. The modulus of elasticity of the material is 10 000 MPa (ISO 527-2) and its melting range is from 220 to 225° C. (DSC measurement to ISO 11357-3). The diameter of the glass fibers is 10 μm.

Comp. ex. in the table means comparative example, and Inv. ex. means example of the invention. SD in table 1 means standard deviation.

Table 2 collates the processing conditions for the sheathing composed of the first plastics component A of each of the comparative examples and examples of the invention.

TABLE 2
Processing conditions for the first plastics component A

| | Inv. | Comp. | Comp. | Comp. |
|---|---|---|---|---|
| | ex. 1 | ex. 1 | ex. 2 | ex. 3 |
| Melt temperature [° C.] | 200 | 170 | 250 | 260 |
| Mold temperature [° C.] | 30 | 30 | 60 | 60 |
| Hold pressure [bar] | 800 | 600 | 600 | 700 |
| Cooling time [s] | 37 | 25 | 25 | 15 |
| Hold pressure time [s] | 5 | 5 | 5 | 5 |

The parameters listed in table 3 apply to the formation of the exterior sheathing composed of the second plastics component B.

TABLE 3
Processing parameters for second plastics component B

| | B |
|---|---|
| Melt temperature [° C.] | 260 |
| Mold temperature [° C.] | 80 |
| Hold pressure [bar] | 700 |
| Injection rate [mm/s] | 160 |
| Cooling time [s] | 12 |
| Hold pressure time [s] | 5 |

The example shows the improvement in the properties of a component composed of a metallic insert part sheathed with a first plastics component A and with a second plastics component B when polyester mixtures described are used as first plastics component A. The previously injected material used in comparative examples 1 to 3 involved straight polyesters or copolyesters as component A, and the corresponding injection-molded parts were either impossible to produce (comparative example 1) or exhibited high leakages even directly after injection molding (comparative example 2) or after as few as 100 temperature shock cycles (comp. ex. 3).

1-15. (canceled)

16. A component comprising an insert part and plastics jacketing composed of at least two plastics components, where the insert part is enclosed by a first plastics component A and there is a second plastics component B enclosing the first plastics component A, wherein the first plastics component A is composed of:
A1: from 5 to 80% by weight, based on the total weight of components A1 and A2, of at least one polyester based on aliphatic and aromatic dicarboxylic acids and on aliphatic dihydroxy compounds;
A2: from 20 to 95% by weight, based on the total weight of components A1 and A2, of at least one homo- or copolyester selected from the group consisting of polylactide (PLA), polycaprolactone, polyhydroxyalkanoates, and polyester derived from aliphatic dicarboxylic acids and from aliphatic diols;
A3: from 0.05 to 15% by weight, based on the total weight of components A1 and A2, a) of a copolymer which contains epoxy groups and which is based on styrene, on acrylate, and/or on methacrylate, b) of a bisphenol A epoxide, or c) of a fatty acid amide or fatty acid ester, or natural oil containing epoxy groups; and
and the second plastics component B is composed of
B1: from 50 to 100% by weight of at least one semicrystalline, thermoplastic polyester based on aromatic dicarboxylic acids and on aliphatic or aromatic dihydroxy compounds and
B2: from 0 to 50% by weight of at least one thermoplastic styrene (co)polymer, in each case based on the polymer content of the second plastics component B.

17. The component according to claim 16, wherein the polyester based on aliphatic and aromatic dicarboxylic acids and on aliphatic dihydroxy compounds comprises, as essential components
1) an acid component composed of
1a) from 30 to 99 mol % of at least one aliphatic or at least one cycloaliphatic dicarboxylic acid, or ester-forming derivatives thereof, or a mixture thereof,
1b) from 1 to 70 mol % of at least one aromatic dicarboxylic acid, or ester-forming derivative thereof, or a mixture thereof, and
1c) from 0 to 5 mol % of a compound containing sulfonate groups,
2) a diol component selected from at least one C₂-C₁₂ alkanediol, from at least one C₅-C₁₀ cycloalkanediol, or a mixture thereof,
and, optionally, also comprising one or more components selected from
3) a component selected from
3a) at least one dihydroxy compound of the formula I comprising ether functions
HO—[(CH₂)ₙ—O]ₘ—H (I)
in which n is 2, 3, or 4, and m is an integer from 2 to 250,
3b) at least one hydroxycarboxylic acid of the formula IIa or IIb 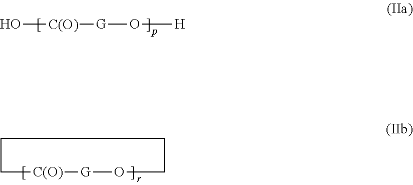
in which p is an integer from 1 to 1500 and r is an integer from 1 to 4, and G is a radical selected from the group consisting of phenylene, —(CH₂)_{q}—, where q is an integer from 1 to 5, —C(R)H— and —C(R)HCH₂, where R is methyl or ethyl,
3c) at least one amino-C₂-C₁₂ alkanol or at least one amino-C₅-C₁₀ cycloalkanol, or a mixture thereof,
3d) at least one diamino-C₁-C₈ alkane,
3e) at least one 2,2′-bisoxazoline of the general formula III 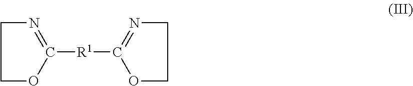
where R¹ is a single bond, a (CH₂), alkylene group, where z=2, 3, or 4, or a phenylene group,
3f) at least one aminocarboxylic acid selected from the group consisting of the natural amino acids, polyamides obtainable via polycondensation of a dicarboxylic acid having from 4 to 6 carbon atoms and of a diamine having from 4 to 10 carbon atoms, compounds of the formulae IVa and IVb 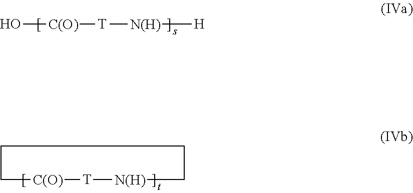
in which s is an integer from 1 to 1500 and t is an integer from 1 to 4, and T is a radical selected from the group consisting of phenylene, —(CH₂)ᵤ—, where u is an integer from 1 to 12, —C(R²)H— and —C(R²)HCH₂, where R² is methyl or ethyl,
and from polyoxazolines having the repeat unit V 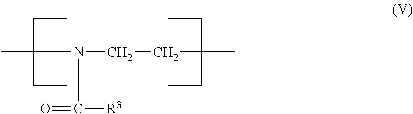
in which R³ is hydrogen, C₁-C₆-alkyl, C₅-C₈-cycloalkyl, phenyl which is unsubstituted or which has up to three substituents that are C₁-C₄-alkyl groups, or is tetrahydrofuryl,
or a mixture of 3a) to 30,
and
4) a component selected from
4a) at least one compound having at least three groups capable of ester formation,
4b) at least one isocyanate,
4c) at least one divinyl ether,
or a mixture of 4a) to 4c).

18. The component according to claim 16, wherein the polyester A1 is a random copolyester of from 10 to 40 mol % of terephthalic acid, 50 mol % of 1,4-butanediol, and from 10 to 40 mol % of adipic acid or sebacic acid, where the entirety of the monomers is 100% by weight.

19. The component according to claim 16, wherein the polyester A1 is a random copolyester of from 15 to 35 mol % of terephthalic acid, 50 mol % of 1,4-butanediol, and from 15 to 35 mol % of adipic acid, where the entirety of the monomers is 100% by weight.

20. The component according to claim 16, wherein at least one of the thermoplastic polyesters A 1 and A2 of the first plastics component A has a lower melting point than the polyester B1 of the second plastics component B, or has a glass transition temperature lower than the melting point of the polyester B1 of the second plastics component.

21. The component according to claim 16, wherein the semicrystalline, thermoplastic polyester B1 of the second plastics component B is a polyalkylene terephthalate or a mixture composed of at least two different polyalkylene terephthalates, where the polyalkylene terephthalate has from 2 to 10 carbon atoms in the alcohol moiety.

22. The component according to claim 21, wherein the polyalkylene terephthalate is a polyethylene terephthalate, polytrimethylene terephthalate, polybutylene terephthalate, or a mixture composed of at least two of these polyalkylene terephthalates.

23. The component according to claim 16, wherein the thermoplastic styrene (co)polymer B2 has been selected from the group consisting of acrylonitrile-styrene-acrylate, acrylonitrile-butadiene-styrene copolymers, styrene-acrylonitrile copolymers, and mixtures thereof.

24. The component according to claim 16, wherein the first plastics component A and/or the second plastics component B also comprises one or more additives, selected from the group consisting of fibrous or particulate fillers, impact modifiers, flame retardants, nucleating agents, carbon black, pigments, colorants, mold-release agents, heat-aging stabilizers, antioxidants, processing stabilizers, and compatibilizers.

25. The component according to claim 16, wherein the first plastics component A comprises from 0.1 to 40% by weight of glass beads, based on the total weight of the first plastics component A.

26. The component according to claim 16, wherein the second plastics component B comprises from 0.1 to 50% by weight of fibrous fillers, in particular glass fibers, based on the total weight of the second plastics component B.

27. The component according to claim 16, wherein the insert part has been manufactured from copper, from a copper-containing alloy, from aluminum, from an aluminum-containing alloy, from titanium, from stainless steel, from a lead-free metal, or from a metal alloy, or from any material with tin coating.

28. The component according to claim 16, wherein the component is a plastics part as used in electronic engineering, a mechatronic component, or a plastics casing with plug-in contacts.

29. A process for the production of a component according to claim 16, comprising the following steps:
a. sheathing of an insert part with a first plastics component A, where the first plastics component A is composed of:
A1: from 5 to 80% by weight, based on the total weight of components A1 and A2, of at least one polyester based on aliphatic and aromatic dicarboxylic acids and on aliphatic dihydroxy compounds;
A2: from 20 to 95% by weight, based on the total weight of components A1 and A2, of at least one homo- or copolyester selected from the group consisting of polylactide (PLA), polycaprolactone, polyhydroxyalkanoates, and polyester derived from aliphatic dicarboxylic acids and from aliphatic diols;
A3: from 0.05 to 15% by weight, based on the total weight of components A1 and A2, a) of a copolymer which contains epoxy groups and which is based on styrene, on acrylate, and/or on methacrylate, b) of a bisphenol A epoxide, or c) of a fatty acid amide or fatty acid ester, or natural oil containing epoxy groups; and
b. molding of exterior sheathing composed of a second plastics component B, where the second plastics component B is composed of:
B1: from 50 to 100% by weight of at least one semicrystalline, thermoplastic polyester based on aromatic dicarboxylic acids and on aliphatic or aromatic dihydroxy compounds and
B2: from 0 to 50% by weight of at least one thermoplastic styrene (co)polymer,
in each case based on the polymer content of the second plastics component B,
where either the insert part is first sheathed with the first plastics component A and then the second plastics component B is applied or the exterior sheathing B is first molded, and then the first plastics component A is charged to a cavity between the exterior sheathing composed of the second plastics component B and the insert part, in order to form the sheathing of the insert part.

30. The process according to claim 29, wherein the sheathing of the insert part with the first plastics component A and the sheathing composed of the second plastics component B are produced via an injection-molding process.
